(19) United States
(12) Patent Application Publication
(10) Pub. No.: US 2017/0248936 A1
(43) Pub. Date: Aug. 31, 2017

(54) ROBOT SYSTEM AND ROBOT CONTROL APPARATUS

(71) Applicant: FANUC CORPORATION, Yamanashi (JP)

(72) Inventor: Eijirou HOSHINO, Yamanashi (JP)

(21) Appl. No.: 15/429,429

(22) Filed: Feb. 10, 2017

(30) Foreign Application Priority Data
Feb. 25, 2016 (JP) 2016-034074

(51) Int. Cl. G05B 19/4061; B25J 9/16

(52) U.S. Cl. CPC G05B 19/4061; B25J 9/1676

(57) ABSTRACT

A robot system includes: a robot; an illumination apparatus disposed in or around the robot; and a control apparatus that controls the robot and the illumination apparatus, wherein the control apparatus includes a robot control unit that operates the robot on the basis of a program, an operation area prediction unit that predicts an operation area of the robot on the basis of the program, and an illumination control unit that turns on or off the illumination apparatus on the basis of the operation area predicted by the operation area prediction unit to display the operation area.

### CROSS-REFERENCE TO RELATED APPLICATIONS

This application is based on and claims priority to Japanese Patent Application No. 2016-034074 filed on Feb. 25, 2016, the content of which is incorporated herein by reference.

### FIELD OF THE INVENTION

The present invention relates to a robot system and a robot control apparatus.

### BACKGROUND OF THE INVENTION

Conventionally, there is a known robot system provided with a sensor to avoid contact between a person and an industrial robot in an environment where the person and the industrial robot coexist and perform work (refer to Japanese Unexamined Utility Model Application, Publication No. S60-62482, for example). In this robot system, in a case where the sensor detects that the person and the industrial robot are in positional relation where there is a possibility of contact between the person and the industrial robot, the industrial robot is operated to reduce speed or stop.

### SUMMARY OF THE INVENTION

However, when the industrial robot is operated to reduce speed or stop in a case where the sensor detects that there is a possibility that the person and the industrial robot come into contact with each other, there is a possibility of causing delay of the whole production facility including the industrial robot, and this situation lowers the rate of operation.

The present invention has been made in view of the above circumstances, and an object of the present invention is to provide a robot system and a robot control apparatus capable of avoiding contact between a person and an industrial robot without lowering the rate of operation of production facility.

In order to make an improvement in the aforementioned situation, the present invention provides the following solutions.

An aspect of the present invention provides a robot system including: a robot; an illumination apparatus which is provided in the robot or which is disposed around the robot; and a control apparatus that controls the robot and the illumination apparatus, wherein the control apparatus includes a robot control unit that operates the robot on the basis of a program, an operation area prediction unit that predicts an operation area of the robot on the basis of the program, and an illumination control unit that turns on or off the illumination apparatus on the basis of the operation area predicted by the operation area prediction unit to display the operation area.

According to this aspect, the operation area prediction unit predicts the operation area of the robot on the basis of the program for operation of the robot caused by the robot control unit, the illumination apparatus provided in the robot, or disposed around the robot is turned on or off on the basis of the predicted operation area. The illumination apparatus is turned on, so that the operation area of the robot is displayed, and an operator around the robot can be notified that the robot moves into the area where the illumination apparatus is turned on. On the other hand, the operator can be notified that the robot does not move into the area where the illumination apparatus is turned off, for a while.

That is, the operation area of the robot is visualized by the illumination apparatus, and it is possible to suppress entrance of the operator into an area where the operator may come into contact with the robot. Consequently, it is possible to avoid contact between a person and the robot while preventing lowering the rate of operation of production facility due to stop or reduction in speed of the robot caused by incorrect entrance of the operator into the area where the operator may come into contact with the robot.

In the above aspect, the illumination apparatus may be disposed so that the illumination apparatus can illuminate a floor over an illumination area including a projection area where all operations of the robot are projected onto the floor, and the illumination control unit controls the illumination apparatus to illuminate an area corresponding to an area where the operation area where the robot is predicted to be disposed is projected onto the floor, on the basis of the predicted operation area.

Consequently, a boundary in the illumination area can be definitely displayed by illumination to the floor by the illumination apparatus, and entrance of the operator into the area where the operator may come into contact with the robot can be more reliably prevented.

In the above aspect, the operation area prediction unit may divide the program into a plurality of program parts, and predicts the operation area for each of the program parts, and the illumination control unit turns on or off the illumination apparatus so as to display the operation area predicted for each of the program parts.

Consequently, before operation of the robot, the operation area where the robot is probable to operate for each program division before execution is predicted and displayed. Consequently, entrance of the operator into the area where the operator may come into contact with the robot can be more reliably prevented.

In the above aspect, the operation area prediction unit may predict the operation area of the robot by the program from present time to predetermined time.

Consequently, the operation area of the robot until the predetermined time can be predicted in real time.

Another aspect of the present invention provides a robot control apparatus including: an operation area prediction unit that predicts an operation area of a robot on the basis of a program for operating the robot; and an illumination control unit that turns on or off an illumination apparatus which is provided in the robot or which is disposed around the robot, on the basis of the operation area predicted by the operation area prediction unit, to display the operation area.

In the above aspect, the operation area prediction unit may divide the program into a plurality of program parts, and predicts the operation area for each of the program parts, and the illumination control unit may turn on or off the illumination apparatus so as to display the operation area predicted for each of the program parts.

In the above aspect, the operation area prediction unit may predict the operation area of the robot by the program from present time to predetermined time.

The present invention can afford an effect of avoiding contact between a person and an industrial robot without lowering the rate of operation of production facility.

### BRIEF DESCRIPTION OF THE DRAWINGS

FIG. 1 is an overall configuration diagram illustrating a robot system according to an embodiment of the present invention.

FIG. 2 is a plan view illustrating the robot system in FIG. 1.

FIG. 3 is a block diagram of the robot system in FIG. 1.

FIG. 4 is a flowchart for illustrating operation of a robot control apparatus provided in the robot system in FIG. 1.

FIG. 5 is an overall configuration diagram illustrating a first modification of the robot system in FIG. 1.

FIG. 6 is an overall configuration diagram illustrating a second modification of the robot system in FIG. 1.

FIG. 7 is a plan view illustrating an illumination area by an illumination apparatus in a third modification of the robot system in FIG. 1.

FIG. 8 is a flowchart for illustrating operation of a robot control apparatus provided in the robot system in FIG. 7.

FIG. 9 is an overall configuration diagram illustrating a fourth modification of the robot system in FIG. 1.

FIG. 10 is a front view for illustrating an illumination area by an illumination apparatus of the robot system in FIG. 9.

FIG. 11 is a schematic plan view for illustrating an operation area of a robot and illumination directions in the robot system in FIG. 9.

FIG. 12 is a schematic plan view for illustrating each illumination direction and each illumination area in FIG. 11.

FIG. 13 is a flowchart for illustrating operation of a robot control apparatus provided in the robot system in FIG. 9.

FIG. 14 is a flowchart for illustrating operation of a robot control apparatus provided in a fifth modification of the robot system in FIG. 1.

### DESCRIPTION OF EMBODIMENTS

A robot system 1 according to an embodiment of the present invention will be described below with reference to the drawings.

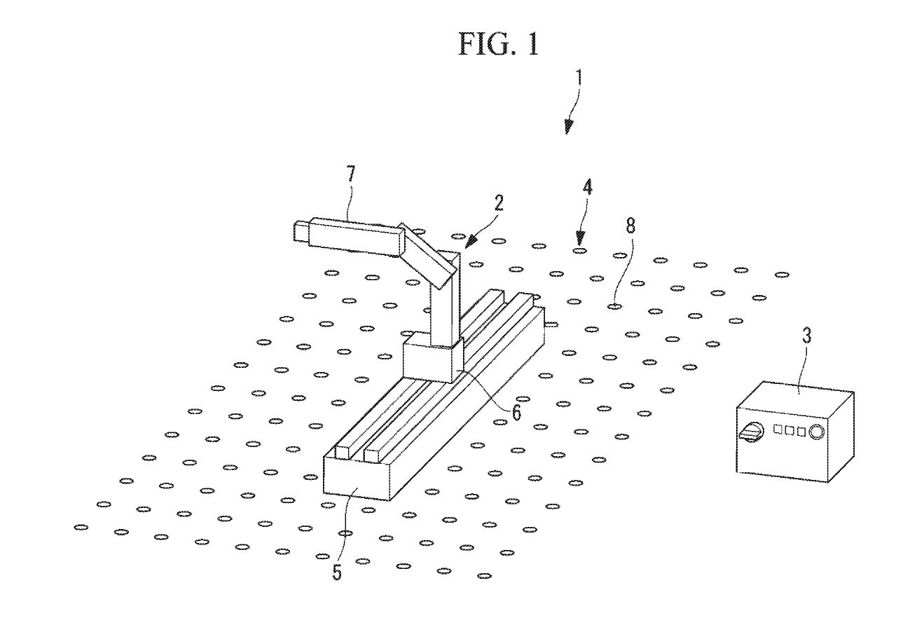

As illustrated in FIG. 1, a robot system 1 according to this embodiment includes a robot 2, a control apparatus (robot control apparatus) 3 that controls the robot 2, and an illumination apparatus 4 disposed around the robot 2.

In the example illustrated in FIG. 1, the robot 2 includes a linear motion shaft 5 installed on a floor, and an upright articulated manipulator unit 7 mounted on a slider 6 horizontally moved by the linear motion shaft 5. A linear operation range of the slider 6 by the linear motion shaft 5 and respective operation ranges of shafts configuring the manipulator unit 7 are predetermined, and the robot 2 can operate in a maximum operation area which is a combination of these operation ranges. A type of the robot 2 is not limited to the robot illustrated in FIG. 1.

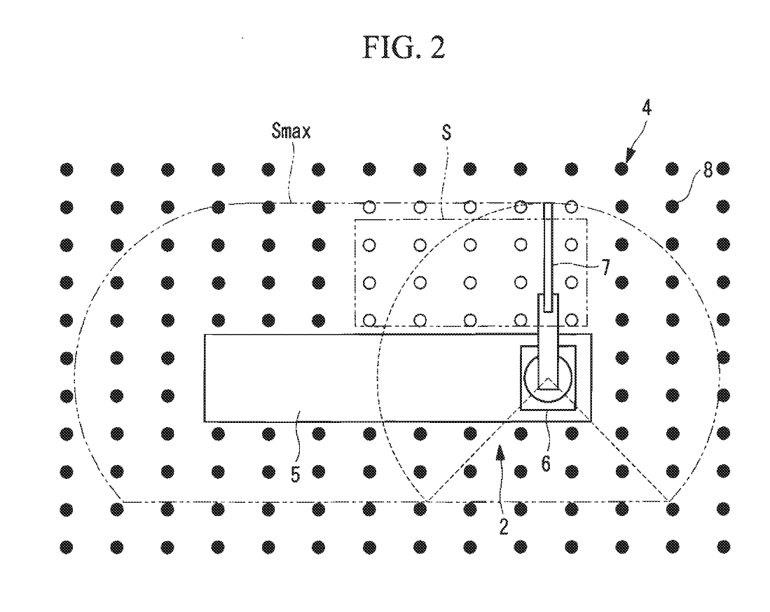

In the example of FIG. 1, the illumination apparatus 4 includes a large number of light emitting portions 8 disposed at intervals on the floor around the robot 2. Each light emitting portion 8 is composed of, for example, an LED light source. As illustrated in FIG. 2, the light emitting portions 8 are disposed over an area (illumination area) including the maximum operation area (projection area) Smax of the robot 2, and wider than the maximum operation area Smax. Data of a position of each light emitting portion 8 is stored in a storage unit 9 described below.

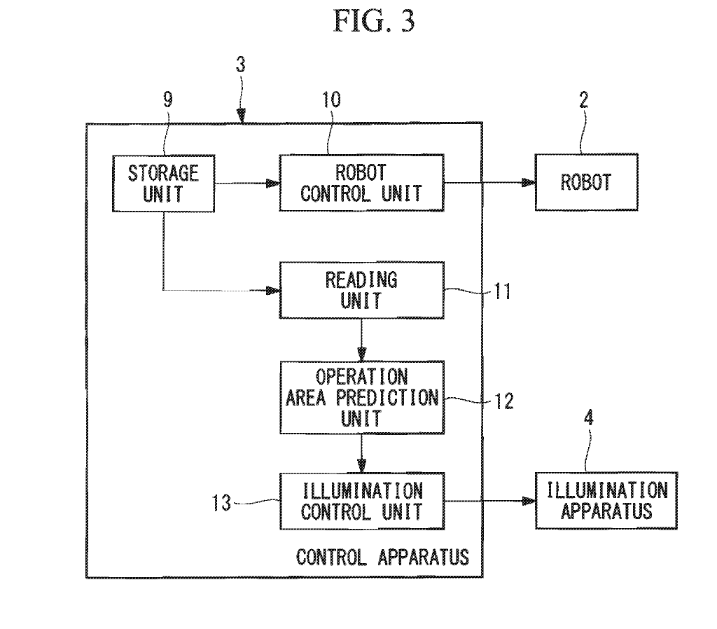

As illustrated in FIG. 3, a control apparatus 3 includes the storage unit 9, and a robot control unit 10 that causes the respective shafts of the robot 2 to operate in accordance with a program stored in the storage unit 9, and is configured to control the illumination apparatus 4 as described below.

That is, as illustrated in FIG. 2 and FIG. 3, the control apparatus 3 includes a reading unit 11 that reads the program for operating the robot 2 from the storage unit 9, an operation area prediction unit 12 that predicts an operation area S of the robot 2 in a predetermined time range, using the program read by the reading unit 11, and an illumination control unit 13 that determines the light emitting portions 8 which are to be turned on, and the light emitting portions 8 which are to be turned off, on the basis of the operation area S predicted by the operation area prediction unit 12, and turns on or off the determined light emitting portions 8.

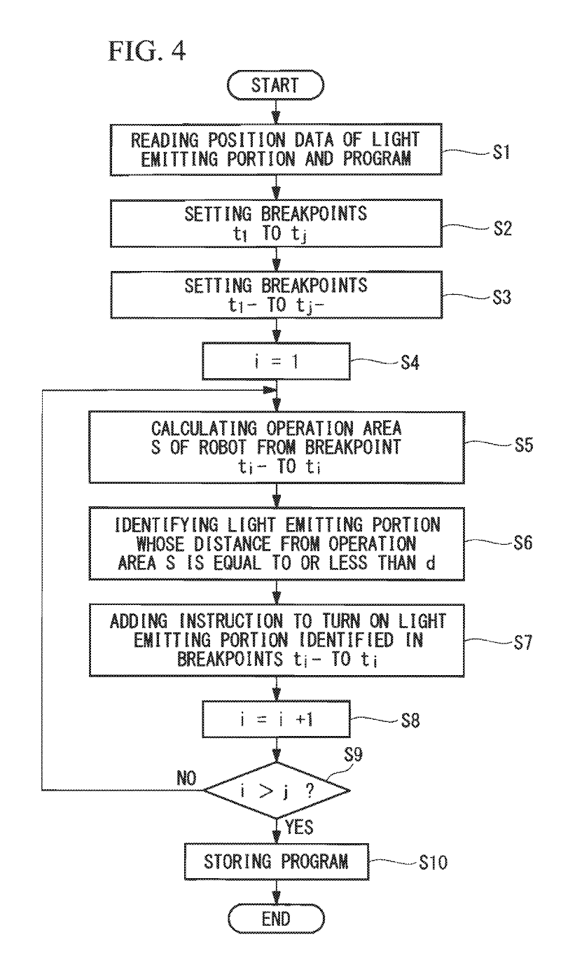

A method for rewriting the program before operation of the robot 2, as control of the illumination apparatus 4 by the control apparatus 3, will be described below with reference to the flowchart of FIG. 4.

The control apparatus 3 first causes the reading unit 11 to read out the data of the position of each light emitting portion 8 stored in the storage unit 9 and the program for operating the robot 2 from the storage unit 9, before the robot 2 is operated by the robot control unit 10 (Step S1).

The operation area prediction unit 12 installs breakpoints in the read program to divide the read program into a plurality of program parts, and predicts the operation area S from an operation locus of the robot 2, which can be taken, regarding each divided program part.

More specifically, the operation area prediction unit 12 sets, for example, breakpoints t1, t2, . . . tj at equal intervals of lines in the read program (Step S2).

Next, respective previous breakpoints of the breakpoints t1, t2, . . . tj in chronological order at the time of operation of the program are selected from t1, t2, . . . tj to be set to breakpoints t1-, t2-, . . . tj-. In a case where previous breakpoints do not exist, the beginning of the program is set to be the breakpoints (Step S3). Then, a constant i is initialized to 1 (Step S4).

The operation area prediction unit 12 obtains the operation area S through which the robot 2 passes, using the program from the breakpoint ti- to the breakpoint ti, by computing (Step S5).

The calculated operation area S is compared with the respective positions of the light emitting portions 8, and the light emitting portions 8 whose distances to the operation area S are smaller than a threshold value d are identified (Step S6). Herein, in a case where the light emitting portions 8 are disposed in the operation area S, the distance to the operation area S is zero, and is smaller than the threshold value d, and therefore the light emitting portions 8 are inevitably identified as the light emitting portions 8 whose distances are smaller than the threshold value d. On the other hand, in a case where the light emitting portions 8 are disposed outside the operation area S, the light emitting portions 8 are identified as a case where the (shortest) distance from the operation area S is smaller than the threshold value d.

In a time period from the breakpoint ti- to the breakpoint ti, the light emitting portions 8 identified in Step S6 are turned on, and an instruction for turning off other light emitting portions 8 are added to the program (Step S7). Then, the constant i is incremented by 1 (Step S8).

Thereafter, it is determined whether or not all the breakpoints are processed (i>j or not) (Step S9). In a case where all the breakpoints are not processed (i≦j), the processes from Step S5 are repeated.

In a case where all the breakpoints are processed, the program rewritten in Step S7 is stored (Step S10).

The control apparatus 3 controls the robot 2 and the illumination apparatus 4 in accordance with the stored program.

Consequently, the operation area S of the robot 2 is predicted for each of the program parts divided by the breakpoints. Additionally, an instruction for turning on the light emitting portions 8 near the predicted operation area S is added to the program, and this program is stored. Accordingly, when the robot 2 is operated in accordance with the stored program, the light emitting portions 8 in the vicinity of the operation area S where robot 2 will operate is turned on for each of the program parts divided by the breakpoints, and other light emitting portions 8 are turned off. In FIG. 2, outlined circles denote the light emitting portions 8 which are turned on, and black painted circle denote the light emitting portions 8 which are turned off. The light emitting portions 8 in an area corresponding to an area (near-field area) where the operation area S is projected onto the floor are turned on.

That is, an operator who exists in the vicinity of the operation area S can recognize whether or not he/she is in the vicinity of the operation area S, since the operation area S of the robot 2 right after operation is displayed by turning on the light emitting portions 8.

Conventionally, in a case where a sensor detects that an operator enters the operation area S, the operator himself/herself does not notice that he/she enters the operation area S. According to this embodiment, the operation area S of the robot 2 can be previously displayed to the operator. Therefore, there is an advantage of avoiding contact between the robot 2 and the operator without stop or reduction in speed of the robot 2.

In this embodiment, the breakpoints are set so as to equally divide the number of lines of the program. Alternatively, the breakpoints may be set such that actual operation of the robot 2 is predicted and substantially equal time intervals are attained.

Conditional branch sometimes exists in the program of the robot 2. Therefore, in such a case, it is difficult to predict the operation area S by simply reading the program.

In a case where the conditional branch exists in the program, the breakpoint may be set right after the conditional branch. Additionally, in the program part including the conditional branch, all the light emitting portions 8 which are probable to be turned on after the conditional branch may be turned on.

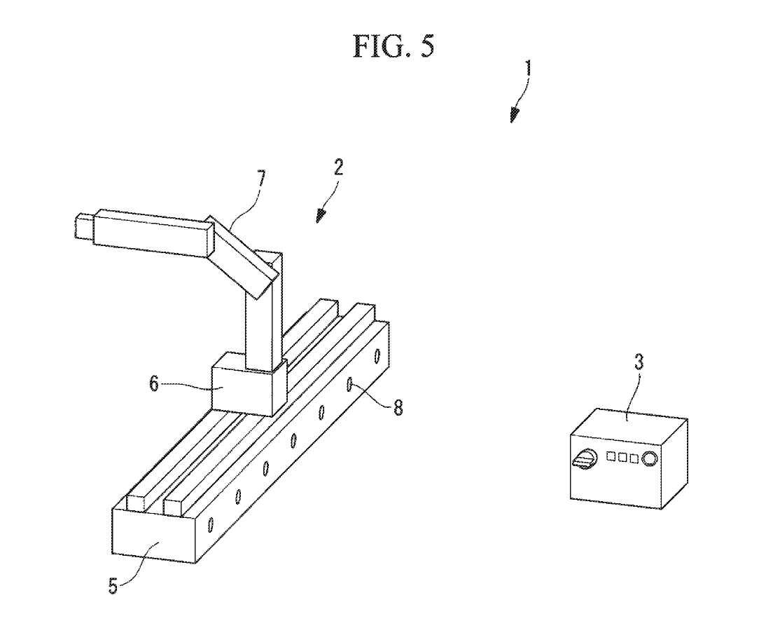

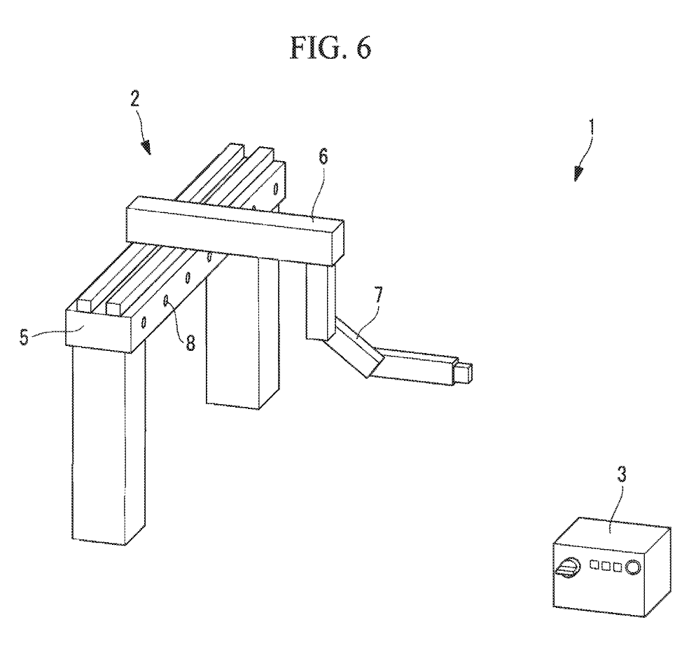

In this embodiment, the light emitting portions 8 are arranged in a matrix manner on the floor. However, the present invention is not limited to this configuration. That is, as an example different from placing them on the floor, the light emitting portions may be disposed on a part of the robot 2, as illustrated in FIG. 5 or FIG. 6. Also in this case, a rough direction of the operation area S of the robot 2 which is to be obtained on and after a present time point can be notified to the operator.

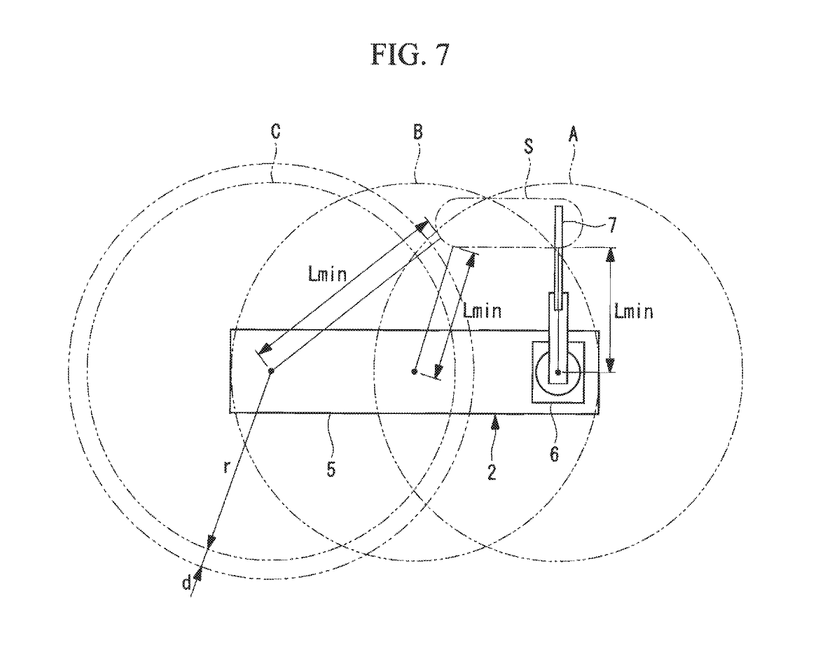

As an example different from placing a large number of the light emitting portions 8, such as LED light sources, at the points on the floor, light emitting portions 8 disposed above the robot 2, for example, on a ceiling may illuminate the floor with the predetermined wide illumination areas. In the example of FIG. 7, an illumination area of each of the light emitting portions 8 is denoted by a circle having a radius r.

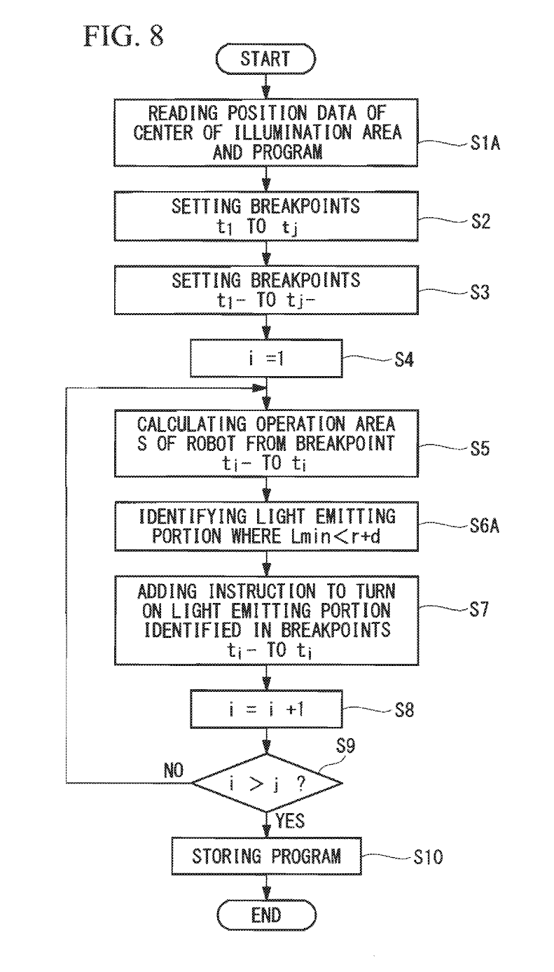

In this case, as illustrated in the flowchart of FIG. 8, in Step S1A, a control apparatus 3 first causes a reading unit 11 to read out data of the radius r and the center position of the illumination area by each light emitting portion 8 stored in the storage unit 9 and a program for operating the robot 2, from the storage unit 9, before the robot 2 is operated by a robot control unit 10.

As illustrated in FIG. 7, in Step S6A, all the light emitting portions 8 in which the shortest distances Lmin between the center positions of the illumination areas and an operation area S are smaller than r+d are identified. In the case of FIG. 7, the light emitting portions 8 in illumination areas A, B are identified, and the light emitting portions 8 in an illumination area C are not identified. Other operation is the same as the operation in the flowchart of FIG. 4.

Each light emitting portion 8 illuminates the floor in the illumination area with the radius r. However, in place of the above, according to the size of the predicted operation area S of the robot 2, the light emitting portions 8 may be turned on so as to change the radii of circles representing the illumination areas. Additionally, in place of representation of the operation area S by turning on or off of the light emitting portions 8, the illumination direction of each light emitting portion 8 may be moved in accordance with the operation area S of the robot 2.

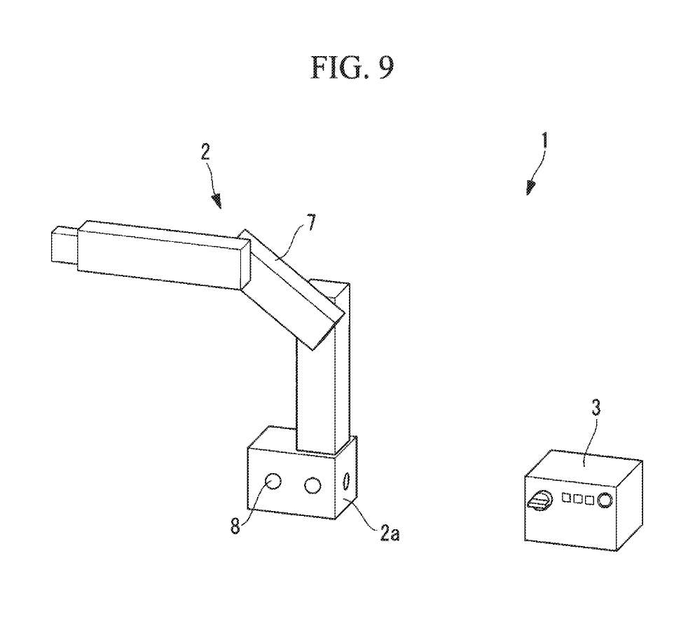

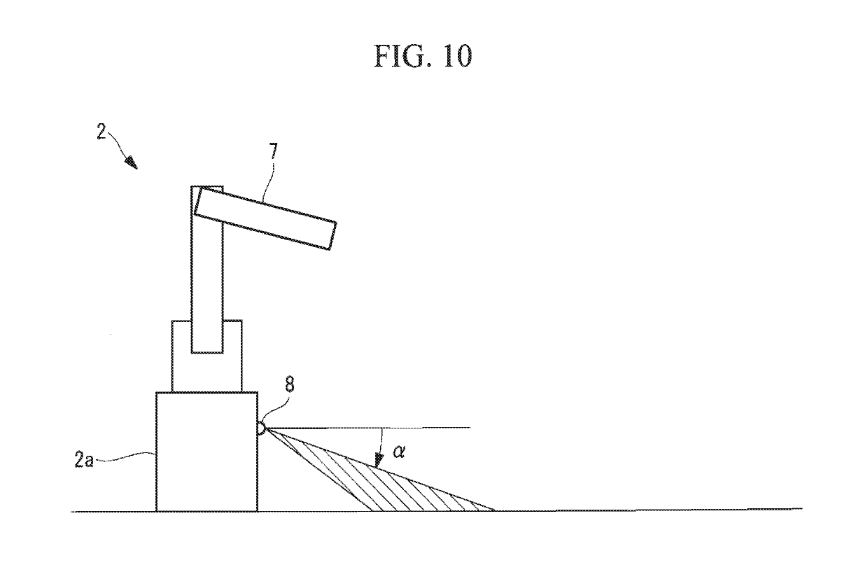

As illustrated in FIG. 9, in a case where a place where light emitting portions 8 are disposed is a part 2a of a robot 2, when the structure of the robot 2 is not large because linear motion shaft 5 or the like is not installed, the size of a part on which the light emitting portions 8 are mounted is reduced. In such a case, in order to display an operation area S of the robot 2, an illumination control unit 13 is configured so as to control the depression angle α of an illumination area by each light emitting portion 8. Consequently, as illustrated in FIG. 10, areas in which a floor is illuminated by the light emitting portions 8 may be adjusted.

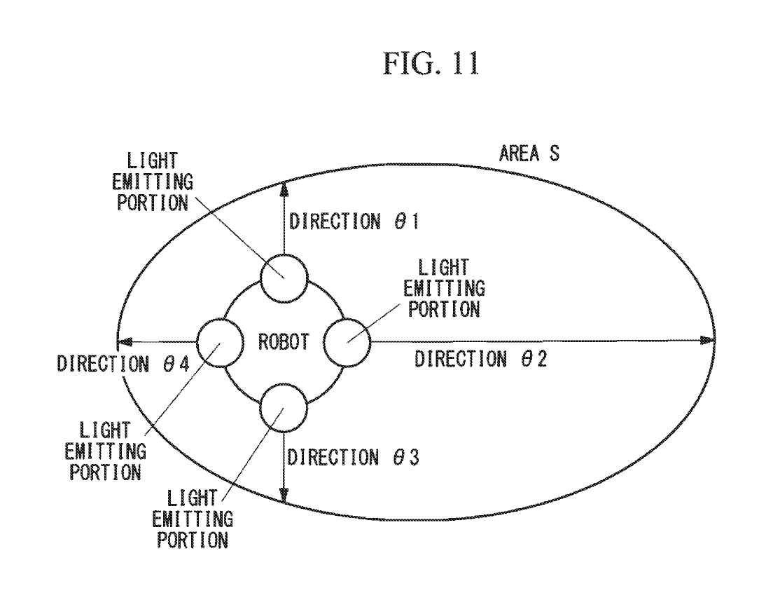

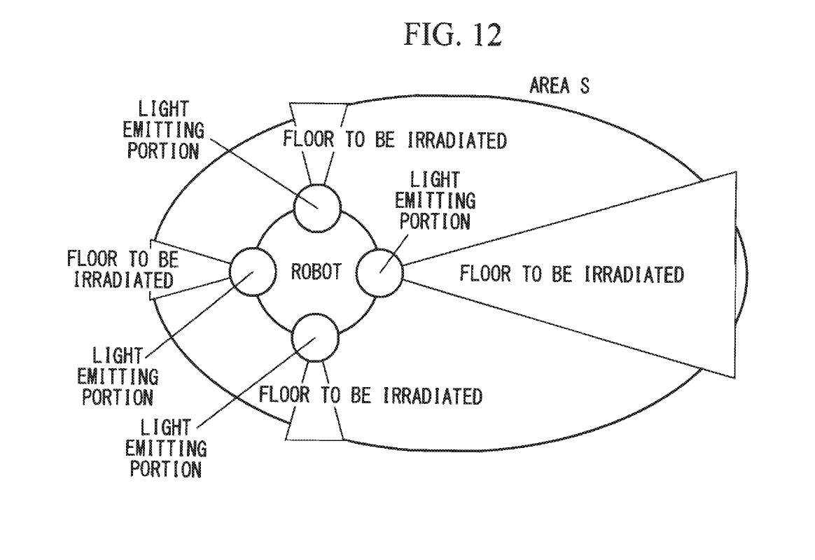

As illustrated in FIG. 11 and FIG. 12, in a case where the operation area S exists at a position close to the robot 2 (directions θ1, θ3, θ4), the depression angles α are increased, so that the illumination areas by the light emitting portions 8 can be made close to a floor which is close to the robot 2. Additionally, in a case where the operation area S reaches a position far from the robot 2 (direction θ2), the depression angles α are reduced, so that the illumination areas by the light emitting portions 8 can be made to reach a floor which is far from the robot 2.

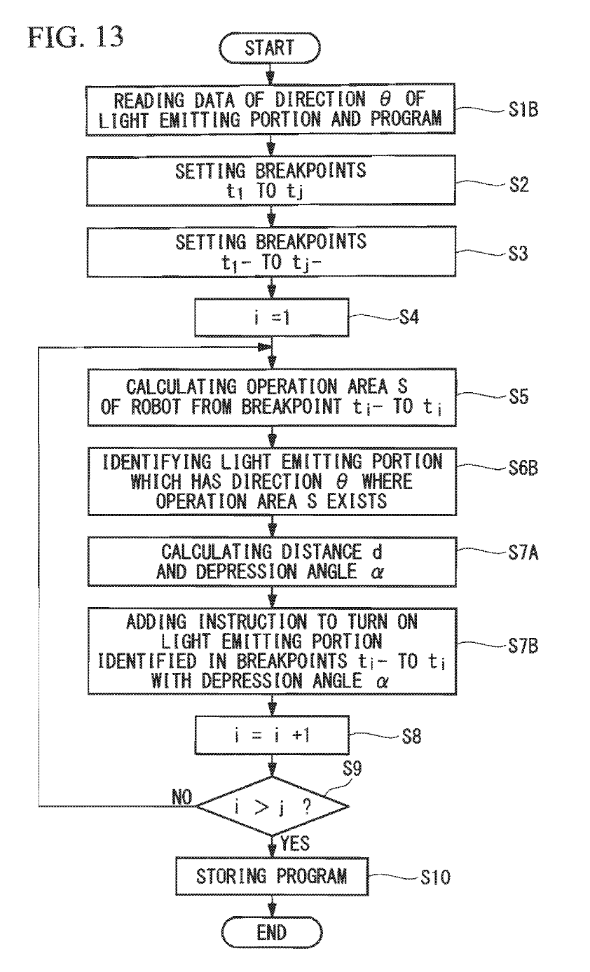

That is, as illustrated in FIG. 13, in Step S1B, data of the angle θ indicating the direction of each light emitting portion 8, and a program are read out from a storage unit 9.

In Step S6B, the light emitting portions 8 which can illuminate in the illumination direction θ in which the operation area S exists are identified.

In Step S7A, a distance d from the robot 2 to the farthest outline of the operation area S is calculated, and the depression angle α for the illumination area of each light emitting portion 8 is calculated such that the illumination area of the floor by each of the identified light emitting portions 8 is substantially equal to the distance d from the robot 2.

Thereafter, in Step S7B, in a time period from a breakpoint ti- to a breakpoint ti, each of the light emitting portions 8 identified in Step S6B is turned on at the depression angle calculated in Step S7A, and an instruction for turning off other light emitting portions 8 are added to the program. Processes other than the above are the same as the processes in FIG. 4.

In each of the above embodiments, the instruction for turning on and off the identified light emitting portions 8 is added to all the program parts divided by the breakpoints in the program prior to the operation of the robot 2. In place of the above, before execution of the respective program parts, the operation locus of the robot 2 may be calculated, the light emitting portions 8 to be turned on may be successively identified, and the identified light emitting portions 8 may be turned on at the time of execution of the program parts.

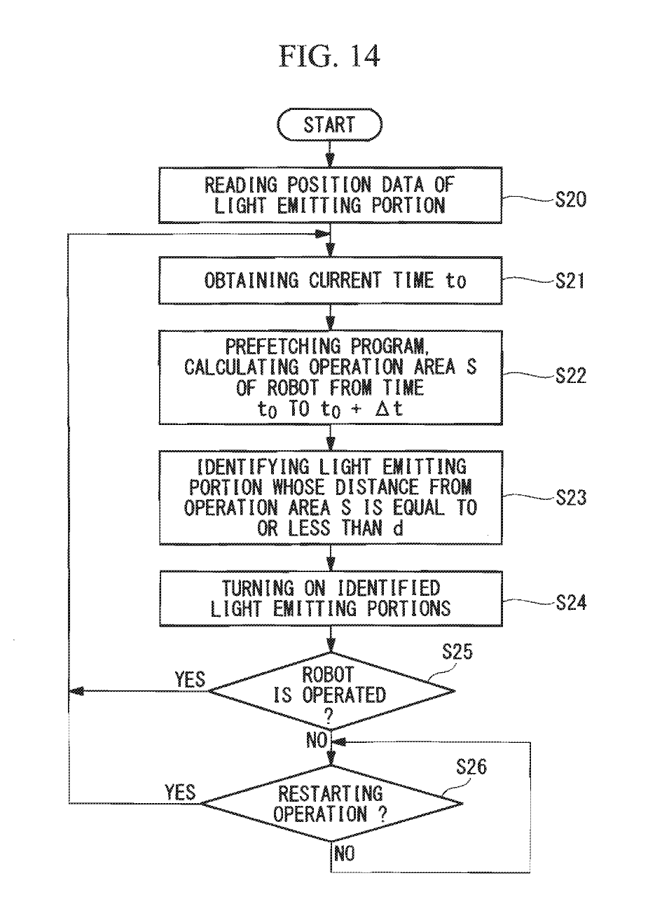

That is, as illustrated in FIG. 14, position data of each light emitting portion 8 is first read out from the storage unit 9 (Step S20), present time t0 is acquired (Step S21), the program stored in the storage unit 9 is prefetched, and the operation area S of the robot 2 from the time t0 to time t0+Δt is calculated (Step S22).

Next, all the light emitting portions 8 each disposed at a position where the distance to the calculated operation area S is smaller than d are identified (Step S23).

Then, all the identified light emitting portions 8 are turned on, and other light emitting portions 8 are turned off (Step S24).

It is determined whether or not the robot 2 is in operation (Step S25). In a case where the robot 2 is in operation, the processes from Step S21 are repeated. In a case where the operation of the robot 2 is stopped, the operation is suspended until the operation is started (Step S26). In a case where the operation of the robot 2 is started, the processes from Step S21 are repeated.

Thus, turning on or off of the light emitting portions 8 is controlled while the operation area S of the robot 2 is predicted in real time without adding the instruction for turning on the light emitting portions 8 to the whole program. Therefore, there is an advantage that standby time before start of the operation of the robot 2 can be shortened even in a case where the program is long.

In this case, since the calculation of the operation area S is continued during the operation of the robot 2, the number of calculations may be reduced by periodic calculation. Additionally, in a case where a conditional branch exists in the program, all probable light emitting portions 8 which are probable to be turned on by the conditional branch during a time period Δt may be turned on.

1. A robot system: comprising:
a robot;
an illumination apparatus provided at least one of in the robot and disposed around the robot; and
a control apparatus that controls the robot and the illumination apparatus, wherein
the control apparatus includes a robot control unit that operates the robot on the basis of a program, an operation area prediction unit that predicts an operation area of the robot on the basis of the program, and an illumination control unit that turns on or off the illumination apparatus on the basis of the operation area predicted by the operation area prediction unit to display the operation area.

2. The robot system according to claim 1, wherein
the illumination apparatus is disposed so that the illumination apparatus can illuminate a floor over an illumination area including a projection area where all operations of the robot are projected onto the floor, and
the illumination control unit controls the illumination apparatus to illuminate an area corresponding to an area where the operation area where the robot is predicted to be disposed is projected onto the floor, on the basis of the predicted operation area.

3. The robot system according to claim 1, wherein
the operation area prediction unit divides the program into a plurality of program parts, and predicts the operation area for each of the program parts, and
the illumination control unit turns on or off the illumination apparatus so as to display the operation area predicted for each of the program parts.

4. The robot system according to claim 1, wherein
the operation area prediction unit predicts the operation area of the robot by the program from present time to predetermined time.

5. A robot control apparatus comprising:
an operation area prediction unit that predicts an operation area of a robot on the basis of a program for operating the robot; and
an illumination control unit that turns on or off an illumination apparatus provided at least one of in the robot and disposed around the robot, on the basis of the operation area predicted by the operation area prediction unit, to display the operation area.

6. The robot control apparatus according to claim 5, wherein
the operation area prediction unit divides the program into a plurality of program parts, and predicts the operation area for each of the program parts, and
the illumination control unit turns on or off the illumination apparatus so as to display the operation area predicted for each of the program parts.

7. The robot control apparatus according to claim 5, wherein
the operation area prediction unit predicts the operation area of the robot by the program from present time to predetermined time.
